(19) United States
(12) Patent Application Publication
(10) Pub. No.: US 2021/0380195 A1
(43) Pub. Date: Dec. 9, 2021

(54) BICYCLE REAR SUSPENSION SYSTEM WITH SELECTABLE AXLE PATHS

(71) Applicant: Suspension Formulas, LLC, Layton, UT (US)

(72) Inventor: Christopher Canfield, Layton, UT (US)

(21) Appl. No.: 16/894,659

(22) Filed: Jun. 5, 2020

(51) Int. Cl. B62K 25/28; B62K 3/06

(52) U.S. Cl. CPC B62K 25/286; B62M 9/00; B62K 3/06

(57) ABSTRACT

A bicycle frame is disclosed. In certain examples, the bicycle frame includes a head tube coupled to a top tube and a down tube, a seat tube coupled to the top tube and the down tube, and an upper pivot point disposed in the seat tube configured to pivotally couple to a rear suspension system. In certain examples, the bicycle frame includes a plurality of lower pivot points disposed in the seat tube configured to pivotally couple to the rear suspension system, each of the plurality of lower pivot points causing, when coupled to the rear suspension system, the rear suspension system to define a different wheel path as a rear wheel of the rear suspension system travels from an extended position to a compressed position.

### FIELD

This disclosure is in the field of suspension systems, and more specifically, relates to rear suspension systems for wheeled vehicles such mountain bikes and motorcycles.

### BACKGROUND

Due to the increase in consumer interest and demand and the advent of extreme sports competitions, the technology for recreational vehicles such as mountain bikes and motorcycles has advanced considerably in recent decades. One area of ongoing interest and development is the suspension systems of such vehicles, especially as relating to their performance, handling and safety. As known to one of skill in the art, for example, when there is an increase in power to the driving wheel or wheels of a bicycle, a motorcycle and other wheeled vehicle (e.g. normally the rear wheel in a bicycle or motorcycle), so as to accelerate the vehicle, some of the force being transmitted to the driving wheel can be cross-coupled into the suspension system. This cross-coupled force often appears as an applied torque or rotational moment on the suspension system which causes the powered end of the vehicle to either pull down (e.g. squat) or push up (e.g. kick). This can be problematic for several reasons.

### SUMMARY

The subject matter of the present application has been developed in response to the present state of the art, and in particular, in response to the problems and needs in the art that have not yet been fully solved by currently available wheeled vehicle suspension systems. Accordingly, the subject matter of the present application has been developed to provide a suspension system for wheeled vehicles, as well as methods of making a suspension system for wheeled vehicles, that overcome at least some shortcomings of the currently-available suspension systems found in the prior art.

For example, according to one representative example, a bicycle frame includes a head tube coupled to a top tube and a down tube, a seat tube coupled to the top tube and the down tube, and an upper pivot point disposed in the seat tube configured to pivotally couple to a rear suspension system. In certain examples, the bicycle frame includes a plurality of lower pivot points disposed in the seat tube configured to pivotally couple to the rear suspension system, each of the plurality of lower pivot points causing, when coupled to the rear suspension system, the rear suspension system to define a different wheel path as a rear wheel of the rear suspension system travels from an extended position to a compressed position.

In certain examples, the bicycle frame also includes a linkage member pivotally coupled to the upper pivot point, and coupling a seatstay with a shock absorber. The shock absorber is coupled at a first end to the linkage member and at a second end to a structural member coupled to the bicycle frame, and where the shock absorber is configured to flexibly maintain a separation between the structural member and the linkage member.

In certain examples, the bicycle frame includes a chainstay coupled at a first end to one of the plurality of lower pivot points and coupled at a second end to the seatstay. The rear suspension system, in some examples, includes the shock absorber, the linkage member, the seatstay, and the chainstay. The bicycle frame may also include an idler pulley coupled to the first end of the chainstay at the one of the plurality of lower pivot points. In certain examples, the seat tube defines a longitudinal axis, and each of the plurality of lower pivot points is centered laterally on the longitudinal axis. In other examples, at least one of the plurality of lower pivot points is disposed to a side of the longitudinal axis.

In certain examples, the bicycle frame includes a bottom bracket shell disposed at a junction of the seat tube and the down tube, and where the plurality of lower pivot points comprises at least a first pivot point at a first distance from the bottom bracket shell, a second pivot point at a second distance from the bottom bracket shell, and a third pivot point at a third distance from the bottom bracket shell.

Also disclosed is a system including a bicycle frame and a rear suspension system. The bicycle frame includes a head tube coupled to a top tube and a down tube, a seat tube coupled to the top tube and the down tube, an upper pivot point disposed in the seat tube configured to pivotally couple to a rear suspension system, and a plurality of lower pivot points disposed in the seat tube configured to pivotally couple to the rear suspension system, each of the plurality of lower pivot points causing, when coupled to the rear suspension system, the rear suspension system to define a different wheel path as a rear wheel of the rear suspension system travels from an extended position to a compressed position. The rear suspension system includes, in certain examples, a linkage member pivotally coupled to the upper pivot point, a seatstay coupled to the linkage member, a chainstay coupled to the seatstay and one of the plurality of lower pivot points, and a shock absorber coupled to the linkage member and the bicycle frame.

The shock absorber, in certain examples, is configured to flexibly maintain a separation between a structural member and the linkage member. The chainstay is coupled at a first end to one of the plurality of lower pivot points and coupled at a second end to the seatstay. The system also includes, in certain examples, an idler pulley coupled to a first end of the chainstay at the one of the plurality of lower pivot points. The seat tube defines a longitudinal axis, and each of the plurality of lower pivot points is centered laterally on the longitudinal axis. In other examples, the seat tube defines a longitudinal axis, and at least one of the plurality of lower pivot points is disposed to a side of the longitudinal axis. The system also includes, in certain examples, a bottom bracket shell disposed at a junction of the seat tube and the down tube, and where the plurality of lower pivot points comprises at least a first pivot point at a first distance from the bottom bracket shell, a second pivot point at a second distance from the bottom bracket shell, and a third pivot point at a third distance from the bottom bracket shell.

A method is also disclosed, and includes providing the frame of a vehicle having a seat tube, providing an upper pivot point disposed in the seat tube configured to pivotally couple to a rear suspension system, and providing a plurality of lower pivot points disposed in the seat tube configured to pivotally couple to the rear suspension system, each of the plurality of lower pivot points causing, when coupled to the rear suspension system, the rear suspension system to define a different wheel path as a rear wheel of the rear suspension system travels from an extended position to a compressed position. The method also includes, in certain examples, coupling, via a linkage member, the rear suspension system to a shock absorber. The method may also include disposing the plurality of lower pivot points along a longitudinal axis defined by the seat tube. The method includes, in certain examples, disposing at least one of the plurality of lower pivot points to a side of a longitudinal axis defined by the seat tube.

### BRIEF DESCRIPTION OF THE DRAWINGS

In order that the advantages of the subject matter of the present disclosure will be readily understood, a more particular description of the subject matter will be rendered by reference to specific embodiments that are illustrated in the appended drawings. Understanding that these drawings depict only typical embodiments of the subject matter of the present disclosure and are not therefore to be considered to be limiting of its scope, the subject matter will be described and explained with additional specificity and detail through the use of the accompanying drawings, in which:

FIG. 1 is a side view diagram illustrating one embodiment of a frame of a mountain bike-type bicycle having a rear suspension system;

FIG. 2 is a side view diagram illustrating the positioning of the pivot points, according to examples of the subject disclosure

FIG. 3 is a side view diagram illustrating another embodiment of the positioning of the pivot points, according to examples of the subject disclosure;

FIGS. 4a and 4b are side view diagrams illustrating the frame, according to examples of the subject disclosure;

FIGS. 5a-7b are side view diagrams illustrating examples of a rear suspension system, according to examples of the subject disclosure;

FIG. 8 is a side view diagram illustrating another embodiment of the bike frame, according to examples of the subject disclosure;

FIGS. 9a-10b are side view diagrams illustrating another example of the bicycle frame, according to examples of the subject disclosure;

FIGS. 11a and 11b are side view diagrams illustrating examples of a rear suspension system in an extended position and a compressed position, respectively, according to examples of the subject disclosure; and

FIG. 12 is a flow chart depicting a method of making a suspension system for supporting a frame of a vehicle on at least one wheel of the vehicle, according to examples of the subject disclosure.

The drawings are not necessarily drawn to scale.

### DETAILED DESCRIPTION

The subject matter of the present disclosure has been developed in response to the present state of the art in wheeled vehicle suspension systems. In particular, the subject matter of the present disclosure addresses the lack of a rear suspension system for mountain bike-type bicycles that are configured to effectively de-couple the suspension system from the driving forces transmitted along a tension segment of a drive chain throughout the range of motion of the suspension system. However, it is contemplated that the present disclosure is not limited to mountain bike-type bicycles, and also has application with upright and recumbent road bicycles and other chain-driven vehicles such as motorcycles, three- and four-wheeled recreational vehicles, etc., which suffer from the same shortcomings. Accordingly, the subject matter of the present disclosure has been developed to provide a suspension system for wheeled vehicles and a method of making a suspension system for wheeled vehicles that may overcome many or all of the above-discussed or other shortcomings in the art.

Reference throughout this specification to features, advantages, or similar language does not imply that all of the features and advantages that may be realized with the subject matter of the present disclosure should be or are in any single embodiment of the subject matter. Rather, language referring to the features and advantages is understood to mean that a specific feature, advantage, or characteristic described in connection with an embodiment is included in at least one embodiment of the subject matter of the present disclosure. Thus, discussion of the features and advantages, and similar language, throughout this specification may, but do not necessarily, refer to the same embodiment.

Furthermore, the described features, structures, advantages, and/or characteristics of the subject matter of the present disclosure may be combined in any suitable manner in one or more embodiments and/or implementations. In the following description, numerous specific details are provided to impart a thorough understanding of embodiments of the subject matter of the present disclosure. One skilled in the relevant art will recognize that the subject matter of the present disclosure may be practiced without one or more of the specific features, details, components, materials, and/or methods of a particular embodiment or implementation. In other instances, additional features and advantages may be recognized in certain embodiments and/or implementations that may not be present in all embodiments or implementations. Further, in some instances, well-known structures, materials, or operations are not shown or described in detail to avoid obscuring aspects of the subject matter of the present disclosure. The features and advantages of the subject matter of the present disclosure will become more fully apparent from the following description and appended claims, or may be learned by the practice of the subject matter as set forth hereinafter.

Similarly, reference throughout this specification to “one embodiment”, “an embodiment”, “a representative embodiment”, or similar language means that a particular feature, structure, or characteristic described in connection with the embodiment is included in at least one embodiment of the subject matter of the present disclosure. Appearances of the phrases “in one embodiment,” “in an embodiment,” and similar language throughout this specification may, but do not necessarily, all refer to the same embodiment. Similarly, the use of the term “implementation” means an implementation having a particular feature, structure, or characteristic described in connection with one or more embodiments of the subject matter of the present disclosure, however, absent an express correlation to indicate otherwise, an implementation may be associated with one or more embodiments.

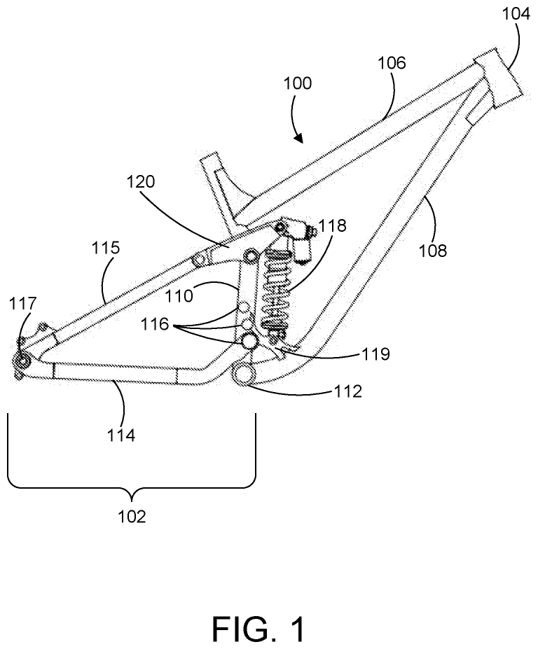

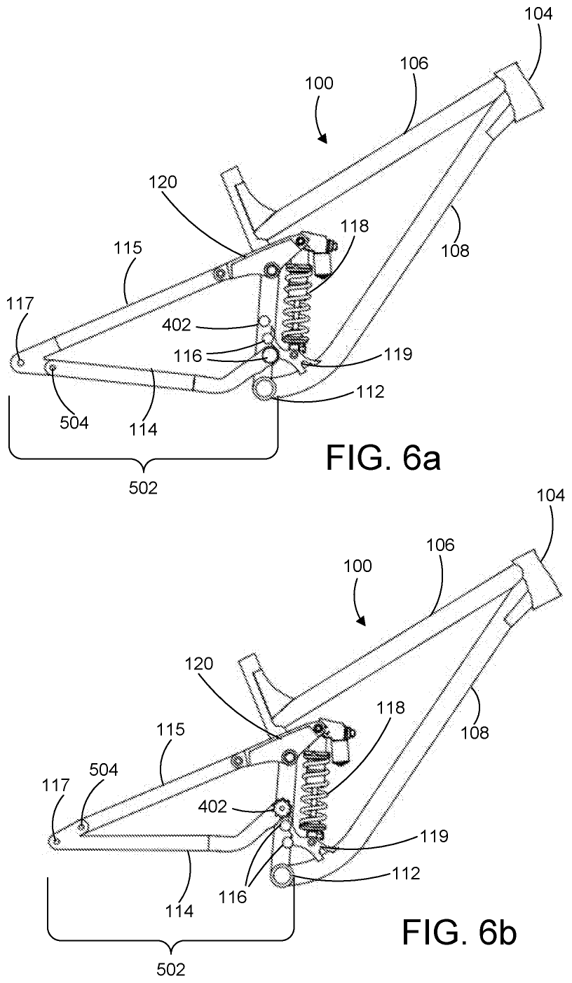

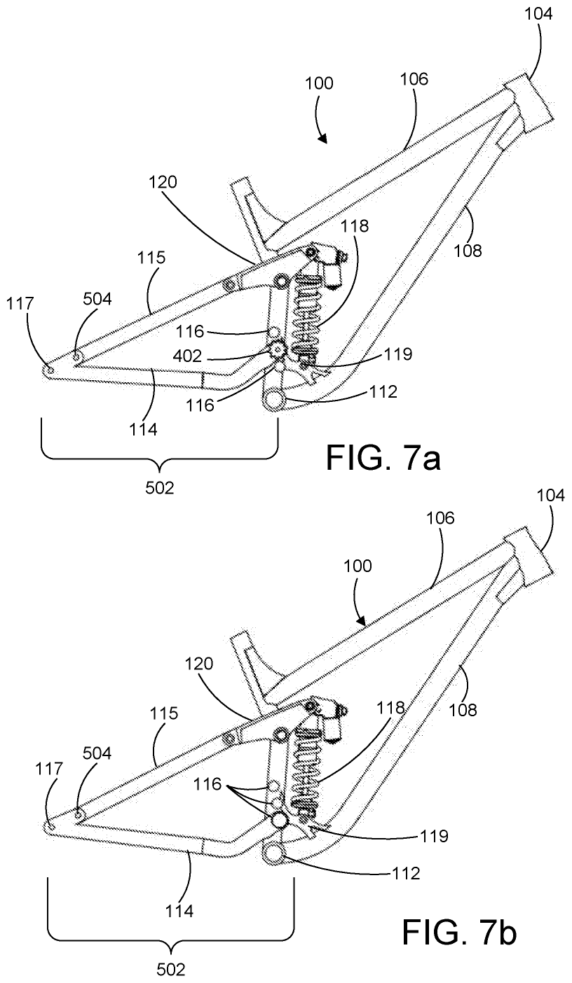

Illustrated in FIGS. 1-16 are several representative embodiments of a suspension system for wheeled vehicles, which embodiments also include one or more methods of making the suspension system. As described herein, the suspension system provides several significant advantages and benefits over other suspension systems and methods of making the suspension systems. However, the recited advantages are not meant to be limiting in any way, as one skilled in the art will appreciate that other advantages may also be realized upon practicing the present disclosure

FIG. 1 is a side view diagram illustrating one embodiment of a bicycle frame 100 of a mountain bike-type bicycle having a rear suspension system 102. The frame 100 includes a head tube 104 which supports a front fork and a front suspension system (not shown) which provides the connection between a front wheel and the frame 100. In addition to the head tube 104, the basic components of the frame 100 may include the top tube 106, the down tube 108, the seat tube 110, and the bottom bracket shell 112.

The rear suspension system 102, as will be recognized by one of skill in the art, may be configured in many different configurations, including but not limited to, multi pivot, split pivot, four-bar, etc. Examples of different suspension configurations suitable for use with the present disclosure will be described in greater detail below with reference to how the rear suspension system 102 is coupled at different pivot points to create different wheel/axle paths, different amounts of suspension travel, etc. In the depicted embodiment, the chainstay 114 of the rear suspension system 102 is couplable to one of multiple pivot points 116 formed in the seat tube. Any type of suitable fastener may be used to couple the chainstay 114 of the rear suspension system 102 to the seat tube 110. As used herein, the term “seat tube” refers to any member or grouping of members, structural or otherwise, that is/are disposed between the top tube 106 and the down tube 108, and extends from the bottom bracket shell to the top tube 106. For example, the seat tube 110 may be a single tube or bar, or alternatively, the seat tube 110 may be formed of combinations of tubes, bars, plates, rods, etc.

For example, the pivot points 116 may comprise openings in the frame 100 through which an axle or rod may pass to secure the rear suspension system 102 to the chainstay 114. Also depicted is the seatstay 115 that couples to the chainstay 114 at the rear axle 117 and the frame 100 at the linkage member 120.

Although depicted here as a group of three pivot points 116, any suitable number of pivot points 116 may be formed in the seat tube 110. Each of the pivot points 116 provides a different wheel path and a different amount of suspension travel. For example, possible amounts of suspension travel with a group of three pivot points 116 include, but are not limited to, 215 mm, 180 mm, and 160 mm. This, beneficially, allows for one mountain bike frame to work in different types of riding disciplines including, but not limited to, downhill, all-mountain, and cross-country, respectively.

In certain examples, the frame 100 includes a shock absorber 118. The shock absorber 118 may be pivotally connected to the frame 100 and a structural member 119 of the rear suspension system 102. Additionally, the shock absorber 118 may couple the frame 100 to the rear suspension system 102 via a linkage member 120. The shock absorber 118 automatically compresses when a force is applied to the end of the shock absorber 118. The forces include, but are not limited to, weight loading (e.g., weight of bike and/or weight of rider), dynamic loading due to irregularities in the terrain, and driving forces applied to pedals of the bike.

As depicted, the frame 100 couples to the rear suspension system 102 via linkage members 120 to the seatstay 115, and via the structural member 119 to the chainstay 114. These components allow the rear suspension 102 to move up and down in relation to the frame 100. The path of a tire coupled to the rear suspension 102 may not follow a simple arc because of the linkage member 120 and structural member 119. As will be discussed in greater detail below, rear suspension system 102 is couplable to one of the different pivot points 116 to cause the rear axle to travel along different tire or wheel paths. In some conditions, a wheel path that moves rearward during a portion of the upward rotation of the rear suspension system 102 is desirable. In other conditions, a wheel path that moves forward is desirable. Beneficially, the examples of the subject disclosure allow for the same frame 100 and rear suspension system 102 to be adjusted for the specific riding environment (i.e., downhill, all-mountain, cross-country).

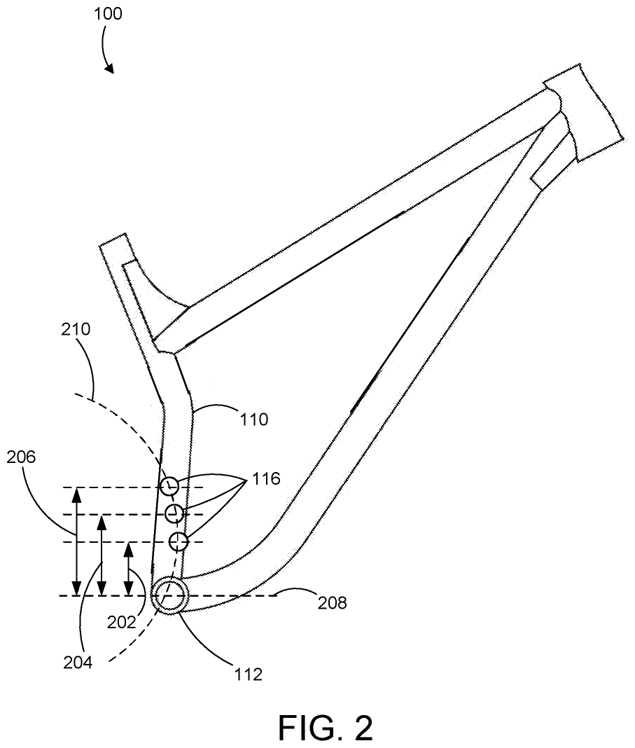

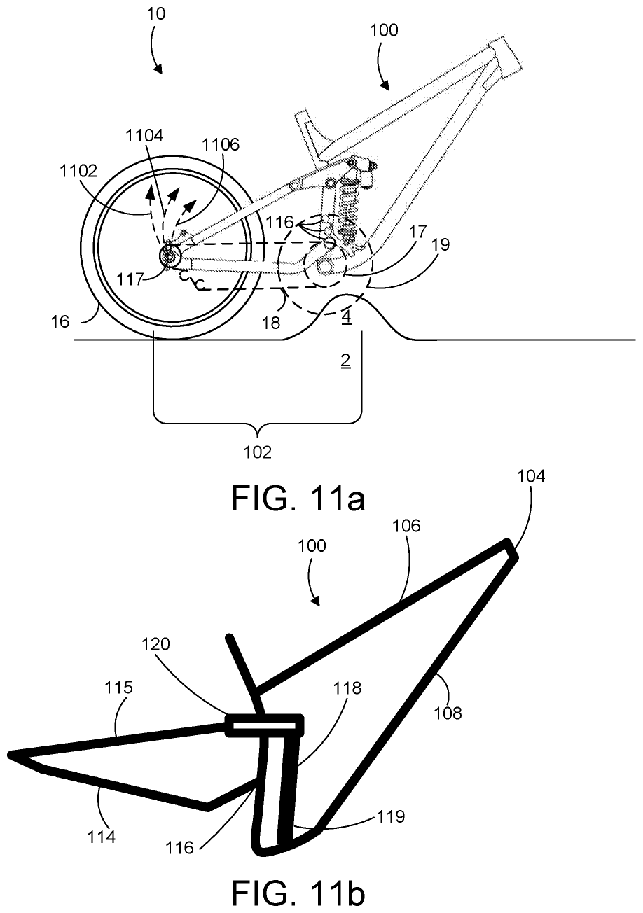

FIG. 2 is a side view diagram illustrating the positioning of the pivot points 116, according to examples of the subject disclosure. The pivot points 116 are positioned, in certain examples, vertically along the seat tube 110 certain distances (first distance 202, second distance 204, and third distance 206) from a horizontal axis 208 defined by the bottom bracket shell 112. The distances between the pivot points 116 and the bottom bracket shell 112 are selected according to a desired rear wheel path and an amount of suspension travel. In some examples, the distances are in the range of between about 10 mm and 100 mm. In other examples, the distance 19 is measured from the chainring 17 (see FIG. 11a, depicted as an outer boundary within which the pivot point 116 may be mounted on the frame). Stated differently, the lower pivot points 116 may be positioned anywhere on the bike frame within a radius of about 100 mm beyond the chain ring 17.

In the depicted embodiment, the pivot points 116 are disposed along an arc path 210 having a radius defined by a distance between the rear axle and one of the pivot points 116. Alternatively, the radius of the arc path 210 may be defined by the distance between the rear axle and the bottom bracket shell 112. In other examples, the arc path 210 is defined by other elements of the rear suspension 102, including, but not limited to, lengths of the seatstay 115, chainstay 114, etc.

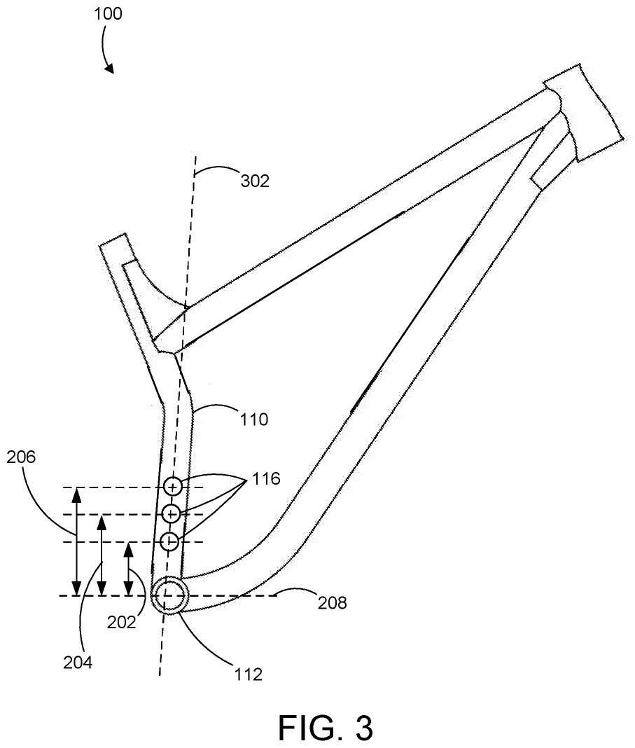

FIG. 3 is a side view diagram illustrating another embodiment of the positioning of the pivot points 116, according to examples of the subject disclosure. In the depicted embodiment, the pivot points 116 are disposed along a longitudinal axis 302 defined by the seat tube 110. The pivot points 116 may be positioned at any distance 202, 204, 206 from the horizontal axis 208.

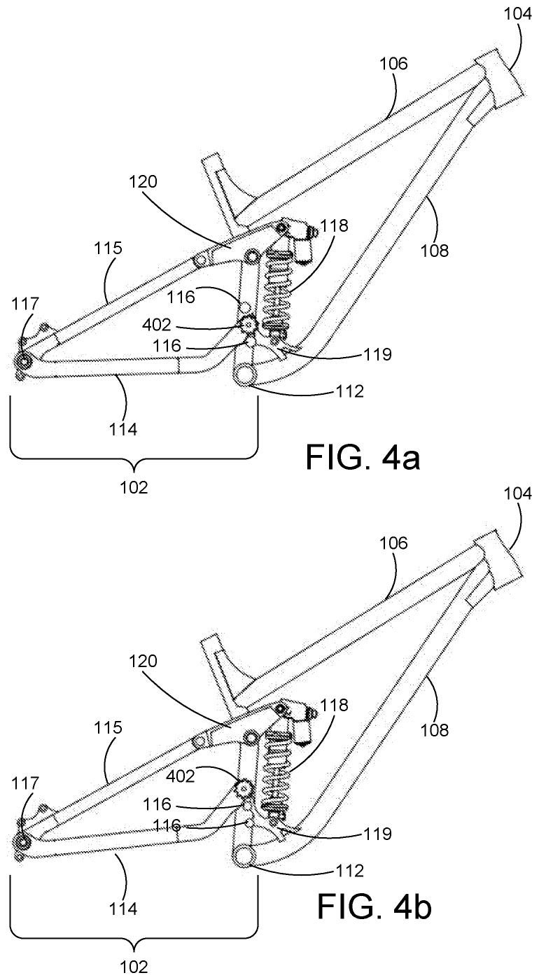

FIGS. 4a and 4b are side view diagrams illustrating the frame 100, according to examples of the subject disclosure. The depicted embodiments illustrate the frame 100 of FIG. 1 with the rear suspension 102 coupled in the middle pivot point 116 (see FIG. 4a) and the upper pivot point 116 (see FIG. 4b). Beneficially, the rear suspension 102 is adjustable by coupling the chainstay 114 to one of the different pivot points 116. As will be described below in greater detail, in certain examples, the seatstay 115 is also positionable by coupling the seatstay 115 to different pivot points.

In certain examples, an idler pulley 402 is coupled to the end of the chainstay 114 at the pivot point 116. In other examples, the idler pulley 402 is mountable anywhere on the bicycle that is reasonable and helpful in guiding the chain towards the chainring (see FIG. 11a). In mountain bikes with wheel paths that can travel rearward upon compression, chain growth occurs as the axle 117 moves away from the bottom bracket shell 112, and subsequently the chainring (not shown). This leads to pedal kickback. The idler pulley 402 routes the chain up and over the chainstay 114 pivot point 116 to prevent chain growth. The idler pulley 402, in certain examples, is rotatably coupled to an outer surface of the chainstay 114. In other examples, the idler pulley 402 is disposed between the chainstay 114 and the seat tube 110.

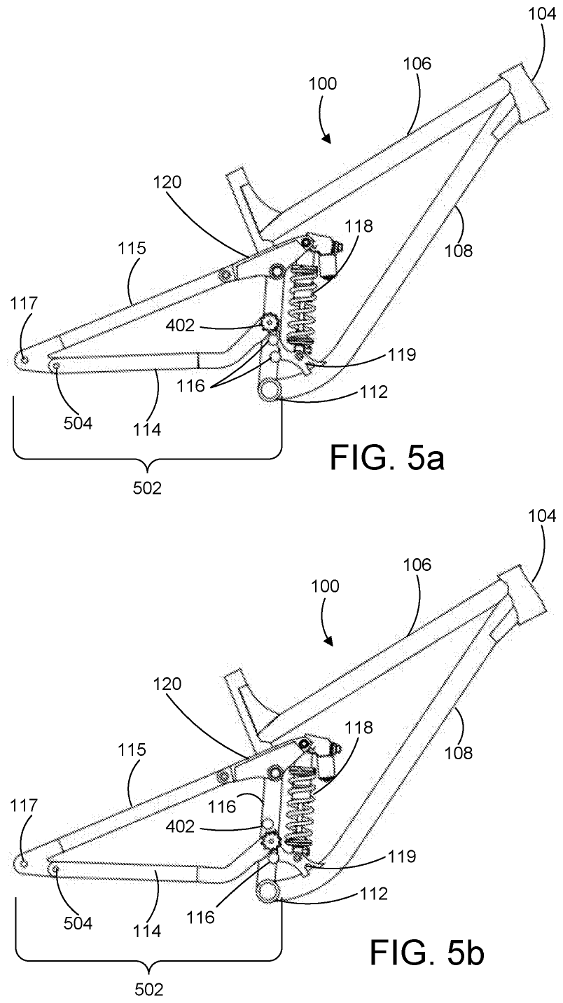

FIGS. 5a-7b are side view diagrams illustrating examples of a rear suspension system 502, according to examples of the subject disclosure. The rear suspension system 502, in certain examples, may be a type of four-bar linkage suspension with a pivot point 504 disposed on the chainstay 114 between the frame pivot point 116 and the axle 117. In other examples, the pivot point 504 is disposed on the seatstay 115 between the linkage member 120 and the axle 117. FIGS. 5a-7b depict the rear suspension system 502 coupled to different pivot points 116, in a manner consistent with that described above, that enables different wheel paths and different amounts of rear suspension travel. The rear suspension 502, as is described above, is positionable relative to the frame 100 by coupling the chainstay 114 to one of the available pivot points 116. The idler pulley 402, in certain examples, is also coupled to the chainstay 114 at one of the pivot points 116.

As with other versions of rear suspension systems, the depicted rear suspension system 502 includes the linkage member 120 that is movable relative to the frame 100 of the bicycle. The linkage member 120 is also directly connected to the shock absorber 118. The shock absorber 118 has an adjustable length and is configured to automatically compress in response to forces applied between the two ends of the shock absorber 118. These forces include the weight loading provided by the weight of the frame 100 of the bicycle as well as weight of the rider. These forces also include the dynamic loading caused by bumps and irregularities in the ground surface being transmitted upwards from the rear wheel towards the frame 100 as the bike travels over the ground surface. The dynamic loading can be reduced or eliminated through the use of a damper element which can be integrated with the shock absorber 118 (e.g., a spring, or air shock).

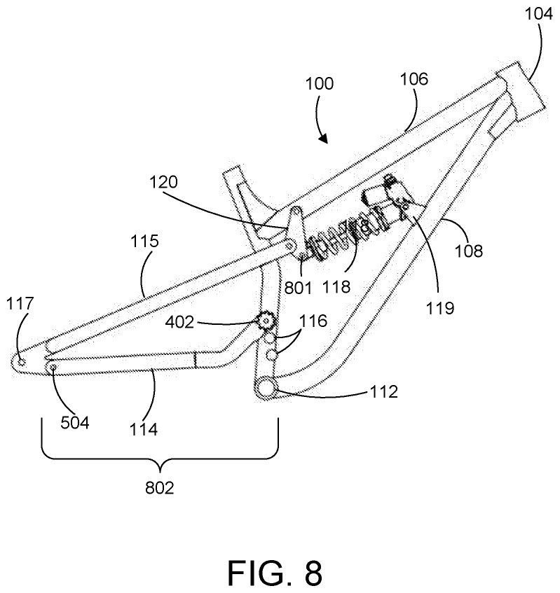

FIG. 8 is a side view diagram illustrating another embodiment of the bike frame 100, according to examples of the subject disclosure. In the depicted embodiment, the shock absorber 118 is positioned in a mostly horizontal configuration with a first end 801 coupled to a linkage member 804, and a second end 806 coupled to the down tube 108. The linkage member 120, in certain examples, is coupled to the top tube 106 and the seatstay 115 of the rear suspension system 802. The rear suspension system 802, as described above with reference to FIGS. 1-7b, may be coupled to one of the pivot points 116. Accordingly, the rear suspension system 802 is adjustable for different wheel paths and amounts of rear suspension travel.

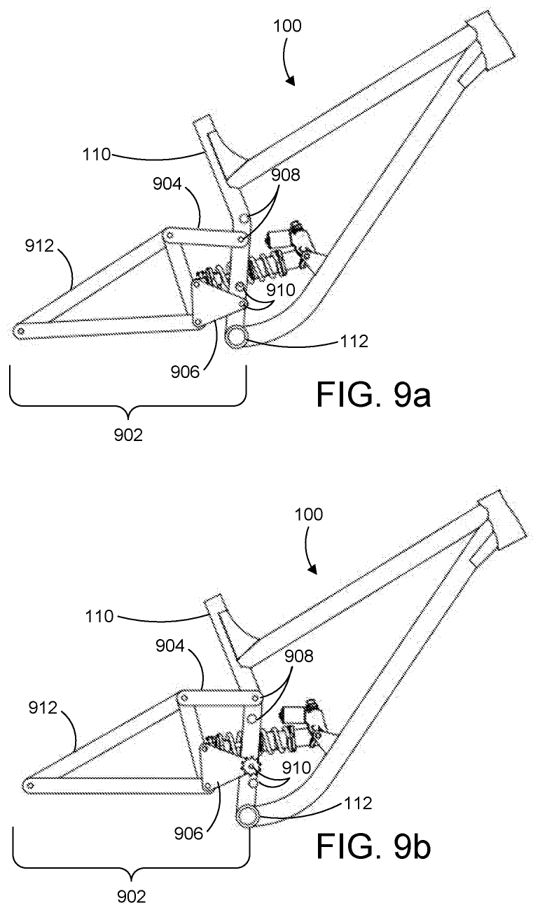

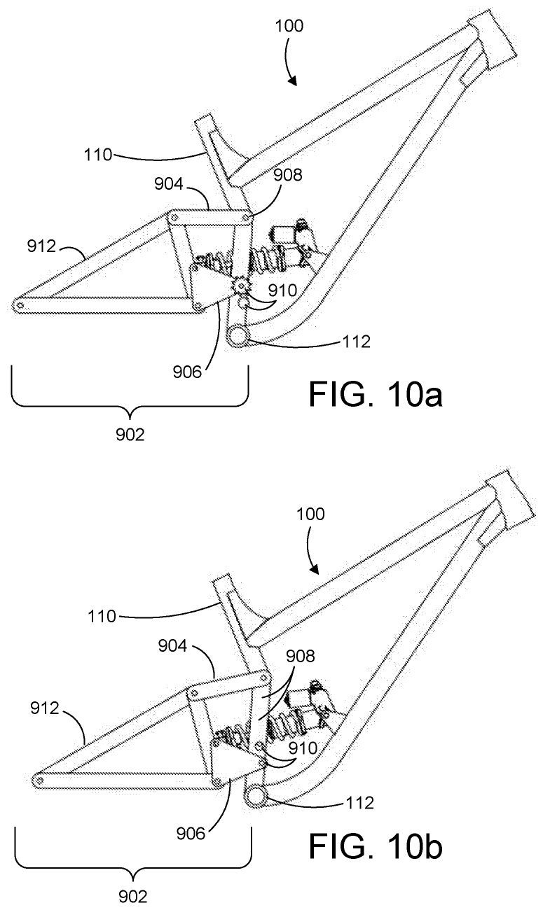

FIGS. 9a-10b are side view diagrams illustrating another example of the bike frame 100, according to examples of the subject disclosure. In the depicted embodiment, the rear suspension system 902 is a floating multi-point suspension system with an upper linkage member 904 and a lower linkage member 906. The upper linkage member 904 is pivotally coupled, in on example to one of a plurality of upper pivot points 908.

In certain examples, the frame 100 has a single upper pivot point (see FIGS. 10a and 10b). Similarly, the lower linkage member 906 is pivotally coupled to one of a plurality of lower pivot points 910. The upper linkage member 904 and the lower linkage member 906 both pivotally couple to the rear suspension triangle 912.

In certain examples, the rear suspension system 902 is adjustable for a greater amount of suspension travel by coupling the upper linkage member 904 and the lower linkage member 906 in the lower of the available pivot points 908, 910, as depicted in FIG. 9a. In certain examples, the upper linkage member 904 and the lower linkage member 906 are coupled to the respective highest or lowest pivot points, so that a distance between the coupled pivot points of the upper linkage member 904 and the lower linkage member 906 is maintained. In other examples, the upper linkage member 904 may be positioned in the highest pivot point of the upper pivot points 908 and the lower linkage member 906 is coupled to the lowest of the lower pivot points 910. As used herein the phrase “highest” refers to a distance between the pivot point and the bottom bracket shell 112. Accordingly, the “highest” is the pivot point closer to the top of the seat tube 110, while the “lowest” will be closer to the bottom bracket shell 112. Stated differently, when referring to the depicted pair of upper pivot points 908, the “highest” pivot point 908 is positioned above the “lowest” pivot point 908. In certain examples, the upper pivot points 908 and/or the lower pivot points 910 include three or more pivot points.

FIGS. 11a and 11b are side view diagrams illustrating examples of a rear suspension system in an extended position (see FIG. 11a) and a compressed position (see FIG. 11b) according to examples of the subject disclosure. The rear suspension system 102 is configured to receive and rotatably support the axle 117 of the rear wheel or tire 16. The bicycle includes a chain ring 17, located on the frame 100, coupled to the tire 16 via a chain 18 that is rotatable to apply a driving force to the tire 16 along a tension segment of the chain 18. The rear suspension system 102 is configured to move up and down relative to the frame 100 of the bicycle.

This movement allows the rear tire 16 to rotate upwards from the normally extended position as depicted to a compressed position in order to accommodate an obstacle or bump 4 on the ground surface 2 over which the bicycle is traveling.

The rear suspension system 102 reacts differently to the obstacle 4 depending on the position of the pivot points 116 to which the rear suspension system 102 is coupled. For example, when coupled to the highest pivot point 116, the rear suspension system 102 has an increased amount of suspension travel, and the wheel path of the wheel/axle 117 travels in an initial rearward direction as depicted by wheel path 1102. Other possible wheel paths 1104, 1106 may correspond to the other pivot points 116. The depicted wheel paths 1102, 1104, 1106 are illustrative only to convey the concept that the wheel path is adjustable by coupling the rear suspension system 102 to a different pivot point 116 depending on the desired handling characteristics of the bicycle. Depending on the type of rear suspension system implemented (e.g., single pivot, multi-pivot, four-bar, floating triangle, etc.) the wheel paths may not follow a simple arc, as depicted, as the rear suspension system rotates upward between the extended position and the compressed position.

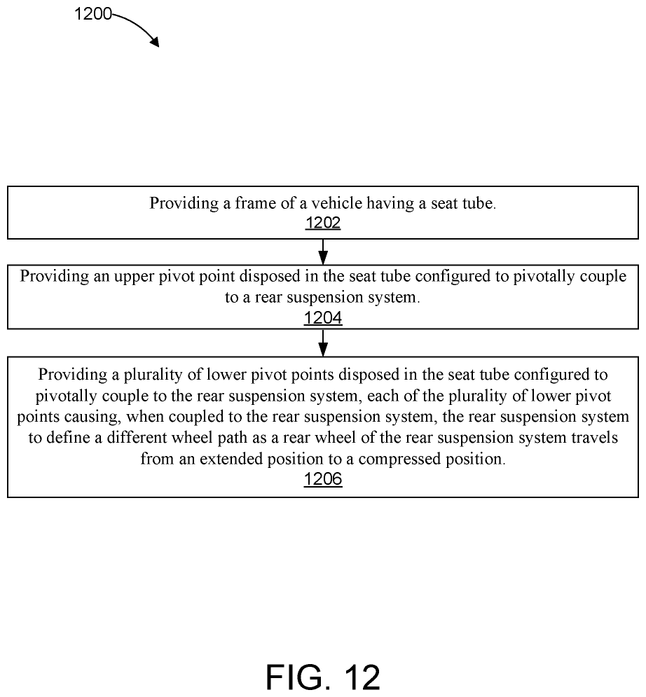

FIG. 12 is a flow chart depicting a method 1200 of making a suspension system for supporting a frame of a vehicle on at least one wheel of the vehicle, in accordance examples of the subject disclosure. The method includes providing 1202 the frame of a vehicle having a seat tube. In certain examples, the method also includes providing 1204 an upper pivot point disposed in the seat tube configured to pivotally couple to a rear suspension system. The method also includes, in certain examples, providing 1206 a plurality of lower pivot points disposed in the seat tube configured to pivotally couple to the rear suspension system, each of the plurality of lower pivot points causing, when coupled to the rear suspension system, the rear suspension system to define a different wheel path as a rear wheel of the rear suspension system travels from an extended position to a compressed position

The method schematic diagram described above is generally set forth as a logical flow chart diagram. As such, the depicted order and labeled steps are indicative of representative embodiments. Other steps and methods may be conceived that are equivalent in function, logic, or effect to one or more steps, or portions thereof, of the methods illustrated in the schematic diagrams. Additionally, the format and symbols employed are provided to explain the logical steps of the schematic diagrams and are understood not to limit the scope of the methods illustrated by the diagrams. Although various arrow types and line types may be employed in the schematic diagrams, they are understood not to limit the scope of the corresponding methods. Indeed, some arrows or other connectors may be used to indicate only the logical flow of a method. For instance, an arrow may indicate a waiting or monitoring period of unspecified duration between enumerated steps of a depicted method. Additionally, the order in which a particular method occurs may or may not strictly adhere to the order of the corresponding steps shown.

The present disclosure may be embodied in other specific forms without departing from its spirit or essential characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

What is claimed is:

1. A bicycle frame comprising:
a head tube coupled to a top tube and a down tube;
a seat tube coupled to the top tube and the down tube;
an upper pivot point disposed in the seat tube configured to pivotally couple to a rear suspension system; and
a plurality of lower pivot points disposed in the seat tube configured to pivotally couple to the rear suspension system, each of the plurality of lower pivot points causing, when coupled to the rear suspension system, the rear suspension system to define a different wheel path as a rear wheel of the rear suspension system travels from an extended position to a compressed position.

2. The bicycle frame of claim 1, further comprising a linkage member pivotally coupled to the upper pivot point, and coupling a seatstay with a shock absorber.

3. The bicycle frame of claim 2, where the shock absorber is coupled at a first end to the linkage member and at a second end to a structural member coupled to the bicycle frame, and where the shock absorber is configured to flexibly maintain a separation between the structural member and the linkage member.

4. The bicycle frame of claim 2, further comprising a chainstay coupled at a first end to one of the plurality of lower pivot points and coupled at a second end to the seatstay.

5. The bicycle frame of claim 4, where the rear suspension system comprises the shock absorber, the linkage member, the seatstay, and the chainstay.

6. The bicycle frame of claim 4, further comprising an idler pulley coupled to the first end of the chainstay.

7. The bicycle frame of claim 1, where the seat tube defines a longitudinal axis, and each of the plurality of lower pivot points is centered laterally on the longitudinal axis.

8. The bicycle frame of claim 1, where the seat tube defines a longitudinal axis, and at least one of the plurality of lower pivot points is disposed to a side of the longitudinal axis.

9. The bicycle frame of claim 1, further comprising a bottom bracket shell disposed at a junction of the seat tube and the down tube, and where the plurality of lower pivot points comprises at least a first pivot point at a first distance from the bottom bracket shell, a second pivot point at a second distance from the bottom bracket shell, and a third pivot point at a third distance from the bottom bracket shell.

10. A system comprising:
a bicycle frame comprising:
a head tube coupled to a top tube and a down tube;
a seat tube coupled to the top tube and the down tube;
an upper pivot point disposed in the seat tube configured to pivotally couple to a rear suspension system; and
a plurality of lower pivot points disposed in the seat tube configured to pivotally couple to the rear suspension system, each of the plurality of lower pivot points causing, when coupled to the rear suspension system, the rear suspension system to define a different wheel path as a rear wheel of the rear suspension system travels from an extended position to a compressed position;
where the rear suspension system supports a portion of the bicycle frame, the rear suspension system comprising:
a linkage member pivotally coupled to the upper pivot point;
a seatstay coupled to the linkage member;
a chainstay coupled to the seatstay and one of the plurality of lower pivot points; and
a shock absorber coupled to the linkage member and the bicycle frame.

11. The system of claim 10, where the shock absorber is configured to flexibly maintain a separation between a structural member and the linkage member.

12. The system of claim 10, where the chainstay is coupled at a first end to one of the plurality of lower pivot points and coupled at a second end to the seatstay.

13. The system of claim 10, further comprising an idler pulley coupled to a first end of the chainstay at the one of the plurality of lower pivot points.

14. The system of claim 10, where the seat tube defines a longitudinal axis, and each of the plurality of lower pivot points is centered laterally on the longitudinal axis.

15. The system of claim 10, where the seat tube defines a longitudinal axis, and at least one of the plurality of lower pivot points is disposed to a side of the longitudinal axis.

16. The system of claim 10, further comprising a bottom bracket shell disposed at a junction of the seat tube and the down tube, and where the plurality of lower pivot points comprises at least a first pivot point at a first distance from the bottom bracket shell, a second pivot point at a second distance from the bottom bracket shell, and a third pivot point at a third distance from the bottom bracket shell.

17. A method of making a suspension system for supporting a frame of a vehicle on at least one wheel of the vehicle, the method comprising:
providing the frame of a vehicle having a seat tube;
providing an upper pivot point disposed in the seat tube configured to pivotally couple to a rear suspension system; and
providing a plurality of lower pivot points disposed in the seat tube configured to pivotally couple to the rear suspension system, each of the plurality of lower pivot points causing, when coupled to the rear suspension system, the rear suspension system to define a different wheel path as a rear wheel of the rear suspension system travels from an extended position to a compressed position.

18. The method of claim 17, further comprising coupling, via a linkage member, the rear suspension system to a shock absorber.

19. The method of claim 17, further comprising disposing the plurality of lower pivot points along a longitudinal axis defined by the seat tube.

20. The method of claim 17, further comprising disposing at least one of the plurality of lower pivot points to a side of a longitudinal axis defined by the seat tube.
